(19) United States
(12) Patent Application Publication
(10) Pub. No.: US 2024/0266653 A1
(43) Pub. Date: Aug. 8, 2024

(54) CYLINDRICAL BATTERY CELL, BATTERY AND METHOD FOR FORMING CYLINDRICAL BATTERY CELL

(71) Applicant: HEFEI GOTION HIGH-TECH POWER ENERGY CO., LTD., Hefei, Anhui (CN)

(72) Inventors: Azad DARBANDI, Gottingen (DE); Tobias SCHMIEG, Gottingen (DE); Qian CHENG, Hefei, Anhui (CN); Chen LI, Hefei, Anhui (CN)

(21) Appl. No.: 18/567,020

(22) PCT Filed: Jul. 5, 2021
(86) PCT No.: PCT/CN2021/104453

§ 371 Date: Dec. 5, 2023

(51) Int. Cl. H01M 50/179; H01M 10/04; H01M 50/107; H01M 50/152; H01M 50/164; H01M 50/534; H01M 50/536; H01M 50/559; H01M 50/562; H01M 50/566; H01M 50/645

(52) U.S. Cl. CPC H01M 50/179; H01M 10/0422; H01M 50/107; H01M 50/152; H01M 50/164; H01M 50/534; H01M 50/536; H01M 50/559; H01M 50/562; H01M 50/566; H01M 50/645

(57) ABSTRACT

A cylindrical battery cell, a battery and a method for forming cylindrical battery cell are provided. In the cylindrical cell, an aluminum terminal of a cap component is welded with an aluminum current collector, a cap plate of the cap component is connected to a copper component; the copper component is at least partly configured on a lateral surface of the jellyroll structure and is isolated from the aluminum current collector. Therefore, the thickness of the cell housing is decreased and an energy gravimetric and volumetric density of the cell is increased. Furthermore, the manufacturing process is simplified and the costs consequently is reduced.

### TECHNICAL FIELD

Embodiments of the present disclosure generally relate to the field of battery, and more particularly, to a cylindrical battery cell, a battery and a method for forming cylindrical battery cell.

### BACKGROUND

A battery (such as an automotive battery) in general includes a plurality of battery cell. As a kind of battery cell, a cylindrical battery cell is used recently. For example, formfactors of the cylindrical battery cell may be from 2170 (diameter is 21 mm and height is 70 mm) to 50120 (diameter is 50 mm and height is 120 mm), and the cylindrical battery cell may at least include a cell housing and a jellyroll structure.

In general, the cylindrical battery cell needs to have a special current path within a cell design in order to ensure enough ampacity. Hence it is required a sophisticated current path design and special care of joints with enough ampacity. For example, compared to 4680 cells, large cells (e.g. 46120) have over 3 times higher energy loss in the current path through the cell housing, in case a thickness of the cell housing has not been changed.

This section introduces aspects that may facilitate a better understanding of the disclosure. Accordingly, the statements of this section are to be read in this light and are not to be understood as admissions about what is in the prior art or what is not in the prior art.

### SUMMARY

However, the inventors found that in order to avoid this effect, the thickness of the cell housing has to be increased accordingly. This considerably reduces an energy gravimetric and volumetric density of the cell, that is, there are less energy and more weight per cell.

In order to solve at least part of the above problems, methods and devices are provided in the present disclosure. Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a cylindrical battery cell, a battery and a method for forming cylindrical battery cell. It is expected to decrease the thickness of the cell housing and increase an energy gravimetric and volumetric density of the cell.

In a first aspect, a cylindrical battery cell is provided. The cylindrical battery cell at least includes: a cell housing having a cylindrical lateral portion and a bottom portion; a jellyroll structure which is arranged inside the cell housing; and a cap component which is configured on the jellyroll structure and is connected to the cylindrical lateral portion on an upper side of the cell housing;
wherein the cap component at least includes an aluminum terminal and a cap plate, the aluminum terminal of the cap component being welded with an aluminum current collector which is welded with one or more flattened tabs of the jellyroll structure on an upper side of the jellyroll structure, the cap plate of the cap component being connected to a copper component; wherein the copper component is at least partly configured on a lateral surface of the jellyroll structure, and is isolated from the aluminum current collector.

In some embodiments, the cap component further includes an insulation element, the insulation element being configured between the cap plate and the aluminum terminal.

In some embodiments, the cap plate is supported by a crimped neck of the cell housing, the cap plate having a hole in which the aluminum terminal is arranged.

In some embodiments, the copper component is a copper foil which includes one or more layers.

In some embodiments, the copper component is configured on the lateral surface of the jellyroll structure by winding one or more copper coils.

In some embodiments, an isolation foil and/or an isolation tape are/is configured between the copper component and the aluminum current collector, to electrically isolate the copper component from the aluminum current collector.

In some embodiments, one or more flattened tabs of the jellyroll structure are welded with a copper current collector on a bottom side of the jellyroll structure, the copper component being welded with the copper current collector.

In some embodiments, the aluminum terminal is welded with the aluminum current collector by using a laser, after the jellyroll structure is inserted into the cell housing.

In some embodiments, the aluminum current collector is pre-shaped and an injection hole is created on the aluminum current collector, the injection hole being through the aluminum current collector and the aluminum terminal after the aluminum terminal is welded with the aluminum current collector.

In some embodiments, the cylindrical battery cell further includes: a sealing pin which is used to seal the injection hole.

In some embodiments, the cylindrical battery cell further includes: a sealing ring which is arranged on the cap plate.

In a second aspect, a method for forming cylindrical battery cell is provided. The method includes: forming a jellyroll structure and a cap component; forming a cell housing having a cylindrical lateral portion and a bottom portion; inserting the jellyroll structure into the cell housing; and configuring the cap component on the jellyroll structure; the cap component being connected to the cylindrical lateral portion on an upper side of the cell housing;
wherein the cap component at least includes an aluminum terminal and a cap plate, the aluminum terminal of the cap component being welded with an aluminum current collector which is welded with one or more flattened tabs of the jellyroll structure on an upper side of the jellyroll structure, the cap plate of the cap component being connected to a copper component; wherein the copper component is at least partly configured on a lateral surface of the jellyroll structure, and is isolated from the aluminum current collector.

In some embodiments, the method further includes: configuring the copper component on the lateral surface of the jellyroll structure.

In some embodiments, the method further includes: configuring an isolation foil and/or an isolation tape between the copper component and the aluminum current collector, to electrically isolate the copper component from the aluminum current collector.

In some embodiments, the method further includes: welding one or more flattened tabs of the jellyroll structure with a copper current collector on a bottom side of the jellyroll structure, and welding the copper component with the copper current collector.

In some embodiments, the method further includes: welding the aluminum terminal with the aluminum current collector by using a laser, after the jellyroll structure is inserted into the cell housing.

In a third aspect, a battery is provided, the battery includes a plurality of the cylindrical battery cells according to the first aspect of the embodiments.

According to various embodiments of the present disclosure, an aluminum terminal of a cap component is welded with an aluminum current collector, a cap plate of the cap component is connected to a copper component; the copper component is at least partly configured on a lateral surface of the jellyroll structure and is isolated from the aluminum current collector.

Therefore, the thickness of the cell housing is decreased and an energy gravimetric and volumetric density of the cell is increased. Furthermore, the manufacturing process is simplified and the costs consequently is reduced.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a cylindrical battery cell in accordance with an embodiment of the present disclosure;

FIG. 2 is a diagram which shows a section view of the cylindrical battery cell in accordance with an embodiment of the present disclosure;

FIG. 3 is a diagram which shows the cap component in accordance with an embodiment of the present disclosure;

FIG. 4 is a diagram which shows a method for forming cylindrical battery cell in accordance with an embodiment of the present disclosure;

FIG. 5 is another diagram which shows a method for forming cylindrical battery cell in accordance with an embodiment of the present disclosure;

FIG. 6 is a diagram which shows a jellyroll structure after a winding process in accordance with an embodiment of the present disclosure;

FIG. 7 is a diagram which shows the jellyroll structure after a tab-flattening process in accordance with an embodiment of the present disclosure;

FIG. 8 is a diagram which shows the jellyroll structure in accordance with an embodiment of the present disclosure;

FIG. 9 is a diagram which shows the jellyroll structure in accordance with an embodiment of the present disclosure;

FIG. 10 is a diagram which shows the jellyroll structure in accordance with an embodiment of the present disclosure;

FIG. 11 is a diagram which shows the jellyroll structure in accordance with an embodiment of the present disclosure;

FIG. 12 is a diagram which shows the jellyroll structure in accordance with an embodiment of the present disclosure;

FIG. 13 is a diagram which shows the jellyroll structure in accordance with an embodiment of the present disclosure;

FIG. 14 is a diagram which shows a cell housing and the jellyroll structure in accordance with an embodiment of the present disclosure;

FIG. 15 is a diagram which shows the cell housing and the jellyroll structure in accordance with an embodiment of the present disclosure;

FIG. 16 is a diagram which shows the cell housing and the jellyroll structure in accordance with an embodiment of the present disclosure;

FIG. 17 is a diagram which shows the cell housing and the jellyroll structure in accordance with an embodiment of the present disclosure;

FIG. 18 is a diagram which shows the cell housing and the jellyroll structure in accordance with an embodiment of the present disclosure;

FIG. 19 is a diagram which shows a battery in accordance with an embodiment of the present disclosure.

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

### A First Aspect of Embodiments

A cylindrical battery cell is provided in the embodiments.

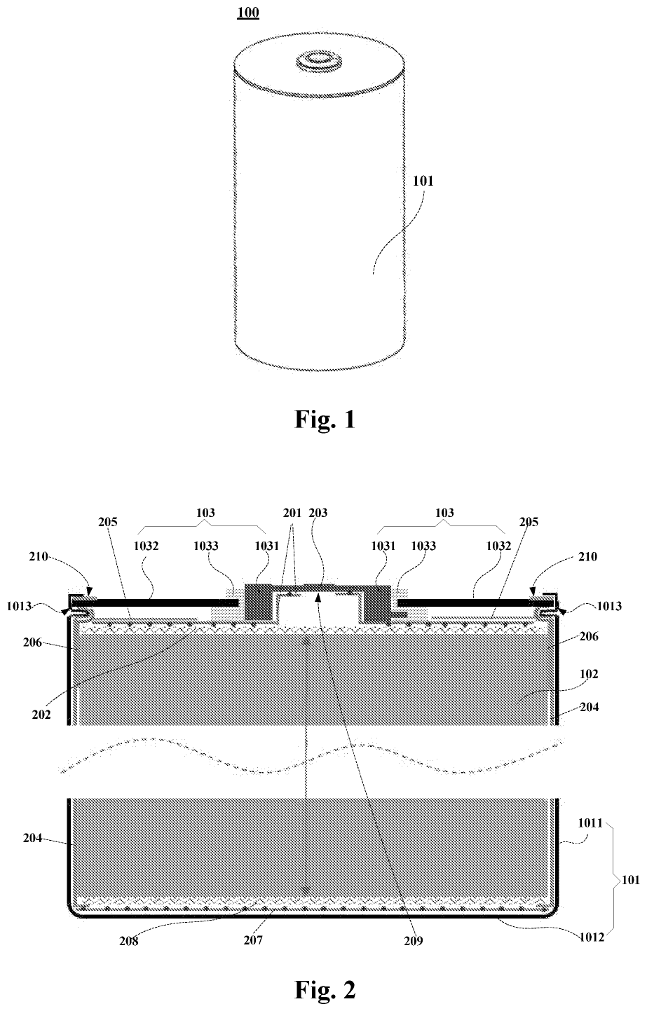

FIG. 1 is a diagram which shows a cylindrical battery cell 100 in accordance with an embodiment of the present disclosure. FIG. 2 is a diagram which shows a section view of the cylindrical battery cell 100 in accordance with an embodiment of the present disclosure.

As shown in FIG. 1 and FIG. 2, a cylindrical battery cell 100 at least includes: a cell housing 101, a jellyroll structure 102 and a cap component 103. The cell housing 101 have a cylindrical lateral portion 1011 and a bottom portion 1012; the cap component 103 is configured on the jellyroll structure 102 and is connected to the cylindrical lateral portion 1011 on an upper side of the cell housing 101.

The jellyroll structure 102 is arranged inside the cell housing 101. For example, the jellyroll structure 102 includes a rolled anode foil, a rolled cathode foil and a rolled separator between the rolled anode foil and the rolled cathode foil. As for the detail of the jellyroll structure 102, please refer to relevant art.

As shown in FIG. 2, the cap component 103 at least includes an aluminum terminal 1031 and a cap plate 1032. The aluminum terminal 1031 of the cap component 103 is welded with an aluminum current collector 201, which is welded with one or more flattened aluminum tabs 202 of the jellyroll structure 102 on an upper side of the jellyroll structure 102, the cap plate 1032 of the cap component 103 is connected to a copper component 204.

As shown in FIG. 2, the copper component 204 is at least partly configured on a lateral surface of the jellyroll structure 102, and the copper component 204 is isolated from the aluminum current collector 201.

It should be appreciated that some components or elements are illustrated only as examples in FIG. 1 and FIG. 2. However, it is not limited thereto, for example, connections or positions of the components or elements may be adjusted, and/or, some components or elements may be omitted.

In this disclosure, the copper component is provided as a significant more efficient path for current within the cell housing. Therefore, the thickness of the cell housing is decreased, and an energy gravimetric and volumetric density of the battery cell is increased. Furthermore, a thermal dispatch (cooling) capability of the battery cell is improved.

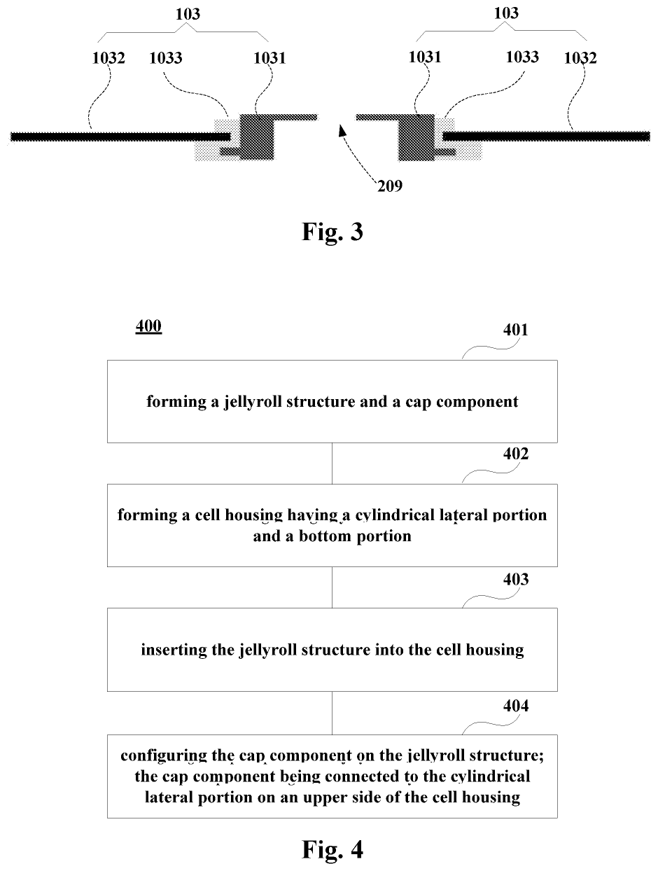

FIG. 3 is a diagram which shows the cap component in accordance with an embodiment of the present disclosure. As shown in FIG. 3, the cap component 103 includes the aluminum terminal 1031 and the cap plate 1032.

As shown in FIG. 3, the cap component 103 further includes an insulation element 1033. The cap plate 1032 have a hole in which the aluminum terminal 1031 is arranged. The insulation element 1033 is configured between the aluminum terminal 1031 and the cap plate 1032.

For example, the cap plate 1032 may be nickel plated steel plate or nickel coated steel, the aluminum terminal 1031 may be Al-Alloy material, the insulation element 1033 may be polymers which are electric insulating and chemically stable vs. electrolyte (e.g. PP, PE, PA etc.), however, it is not limited thereto.

As shown in FIG. 2, the cap plate 1032 is arranged on the upper side of the cell housing 101, and the cap plate 1032 is supported by a crimped neck 1013 in the cylindrical lateral portion 1011 of the cell housing 101.

In some embodiments, the cap component 103 is formed by using a plastic injection mold. Therefore, a manufacturing process is simplified and costs consequently is reduced, and it is not limited thereto, the cap component 103 may be formed by other processes.

In some embodiments, the copper component 204 is a copper foil which includes one or more layers. For example, the copper component 204 may include a plurality of copper layers in a radial direction, and the plurality of copper layers are configured on the lateral surface of the jellyroll structure 102.

In some embodiments, the copper component 204 is configured on the lateral surface of the jellyroll structure 102 by winding one or more copper coils. The copper coils may be wound to form one or more layers in a radial direction.

Therefore, the copper component 204 is electrically connected to the cap plate 1032. Integration/joining of the copper component to the cap component is implemented as a current collector. Furthermore, the copper component 204 is connected to the cap plate 1032 without a welding process, a manufacturing process is simplified and costs consequently is reduced.

In some embodiments, the aluminum terminal 1031 is welded with the aluminum current collector 201 by using a laser, after the jellyroll structure 102 is inserted into the cell housing 101.

Therefore, joining/welding the cap component with the jellyroll structure is achieved by using a laser from outside of the cell housing, while risk of corrosion of cell housing is not introduced.

In this disclosure, a laser is used to weld some components in a welding process, but it is not limited thereto. For example, other ways such as an ultrasonic may be used in the welding process.

In some embodiments, as shown in FIG. 2, an isolation foil 205 and/or an isolation tape 206 are/is configured between the copper component 204 and the aluminum current collector 201, to electrically isolate the copper component 204 from the aluminum current collector 201.

In some embodiments, one or more flattened tabs of the jellyroll structure are welded with a copper current collector on a bottom side of the jellyroll structure, and the copper component is welded with the copper current collector.

For example, as shown in FIG. 2, a copper current collector 207 is provided on the bottom side of the jellyroll structure 102. Furthermore, there are one or more flattened copper tabs 208 in the jellyroll structure 102. The flattened copper tabs 208 of the jellyroll structure 102 are pre-welded with the copper current collector 207 on the bottom side of the jellyroll structure 102 (some dots in FIG. 2 are used to demonstrate laser welding footprints).

As shown in FIG. 2, the copper component 204 is welded with the copper current collector 207 by using a laser. Therefore, the copper current collector 207 is pre-welded to the flattened copper tabs, and the copper component 204 is electrically connected to the copper current collector 207, a significant more efficient path for current is provided within the cell housing.

In some embodiments, the cell housing is made up of steel, it is not limited thereto.

In some embodiments, the aluminum current collector 201 is pre-shaped and an injection hole is created on the aluminum current collector 201, the injection hole being through the aluminum current collector 201 and the aluminum terminal 1031 after the aluminum terminal 1031 is welded with the aluminum current collector 201.

For example, as shown in FIG. 2, an aluminum current collector 201 is provided on the upper side of the jellyroll structure 102. The aluminum current collector 201 is pre-shaped and an injection hole 209 is created on the aluminum current collector 201.

In some embodiments, as shown in FIG. 2, the cylindrical battery cell 100 further includes: a sealing ring 210 which is arranged on the cap plate 1032. As shown in FIG. 2, the cylindrical battery cell 100 further includes: a sealing pin 203 which is used to seal the injection hole 209.

In this disclosure, a copper component is used for the current path within the cell housing. Therefore, electrical conduction of the cell housing is increased significantly, while the total thickness of the cell housing is reduced and a volumetric filling ratio is increased. Furthermore, the technique solution of this disclosure can maximize a space usage of the cell (higher volumetric filling ratio, higher energy content per cell, lower cost per cell mechanic).

Furthermore, a plastic injection mold component in combination with the jellyroll structure enables laser welding of positive terminal from outside of the cell housing. Therefore, the technical solution simplifies significantly the cell structure, reduces number of parts, enables a lean production process (higher quality and lower scrap rate), which in turn reduces cell manufacturing costs considerably.

In addition, the technical solution enhances substantially a thermal conduction path. Concurrently, a high in-plane thermal conduction of the jellyroll structure (in vertical axis) is achieved, this enables implementation of bottom cooling at module/pack level.

For example, implementation of bottom cooling increases volumetric filling ratio at module/pack level by minimize 5%. Implementation of bottom cooling resolves many technical challenges in integration and reduces manufacturing costs.

It is to be understood that, the above examples or embodiments are discussed for illustration, rather than limitation. Those skilled in the art would appreciate that there may be many other embodiments or examples within the scope of the present disclosure.

It can be seen from the above embodiments, an aluminum terminal of a cap component is welded with an aluminum current collector, a cap plate of the cap component is connected to a copper component; the copper component is at least partly configured on a lateral surface of the jellyroll structure and is isolated from the aluminum current collector. Therefore, the thickness of the cell housing is decreased and an energy gravimetric and volumetric density of the cell is increased. Furthermore, the manufacturing process is simplified and costs consequently is reduced.

### A Second Aspect of Embodiments

A method for forming cylindrical battery cell is provided in the embodiments. The corresponding devices are illustrated in the first aspect of embodiments, and the same contents as those in the first aspect of embodiments are omitted.

FIG. 4 is a diagram which shows a method for forming cylindrical battery cell in accordance with an embodiment of the present disclosure. As shown in FIG. 4, a method 400 for forming cylindrical battery cell includes:
401, forming a jellyroll structure and a cap component;
402, forming a cell housing having a cylindrical lateral portion and a bottom portion;
403, inserting the jellyroll structure into the cell housing; and
404, configuring the cap component on the jellyroll structure; the cap component being connected to the cylindrical lateral portion on an upper side of the cell housing.

In this disclosure, the cap component at least includes an aluminum terminal and a cap plate, the aluminum terminal of the cap component being welded with an aluminum current collector which is welded with one or more flattened tabs of the jellyroll structure on an upper side of the jellyroll structure, the cap plate of the cap component being connected to a copper component; wherein the copper component is at least partly configured on a lateral surface of the jellyroll structure, and is isolated from the aluminum current collector.

It should be appreciated that FIG. 4 is only an example of the disclosure, but it is not limited thereto. For example, the order of operations at blocks or steps may be adjusted, and/or, some blocks or steps may be omitted. Moreover, some blocks or steps not shown in FIG. 4 may be added.

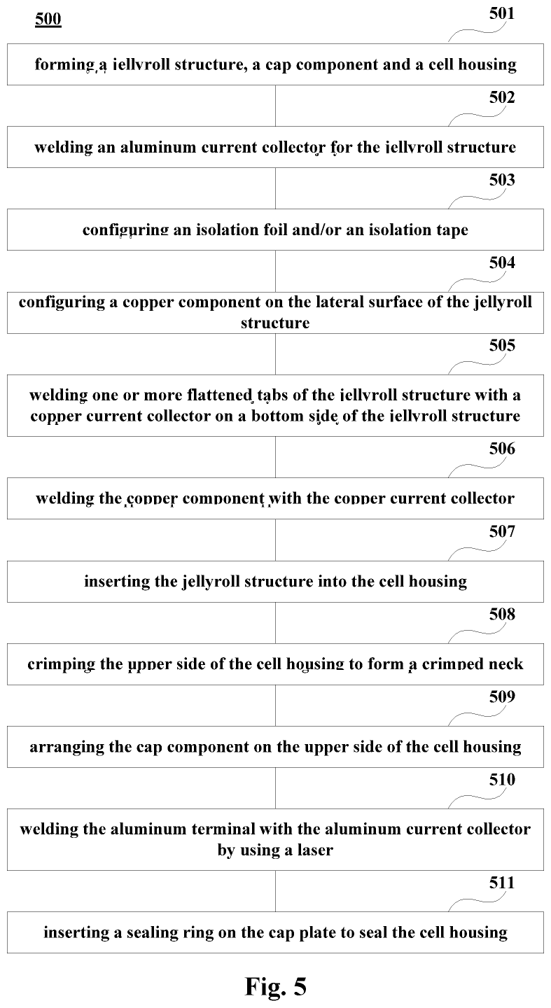

FIG. 5 is another diagram which shows a method for forming cylindrical battery cell in accordance with an embodiment of the present disclosure. As shown in FIG. 5, a method 500 for forming cylindrical battery cell includes:
501, forming a jellyroll structure, a cap component and a cell housing.

For example, the jellyroll structure, the cap component and the cell housing are separately formed by respective processes. The details of the processes are omitted in this disclosure, and please refer to relevant art. For example, the cap component 103 is formed by using a plastic injection mold. For example, the structure of the cap component 103 is shown in FIG. 3.

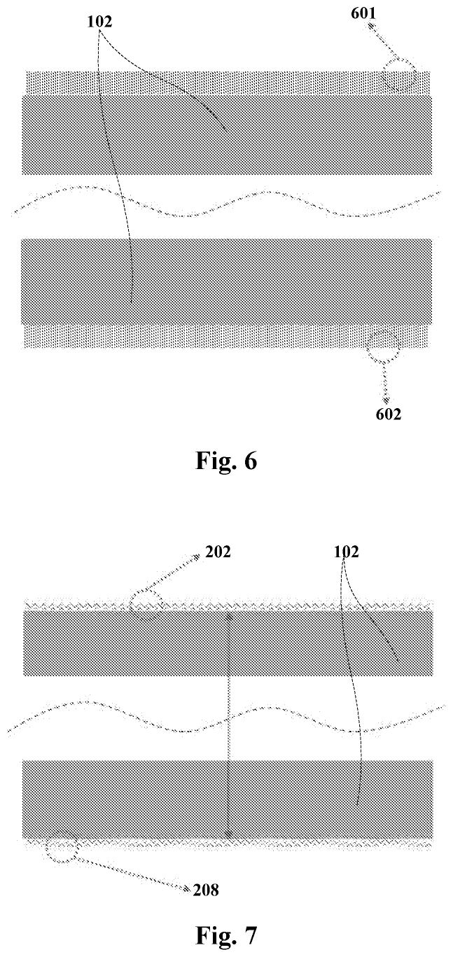

FIG. 6 is a diagram which shows a jellyroll structure after a winding process in accordance with an embodiment of the present disclosure. As shown in FIG. 6, there are some aluminum tabs 601 on the upper side of the jellyroll structure 102, and there are some copper tabs 602 on the bottom side of the jellyroll structure 102.

FIG. 7 is a diagram which shows the jellyroll structure after a tab-flattening process in accordance with an embodiment of the present disclosure. As shown in FIG. 7, there are some flattened aluminum tabs 202 on the upper side of the jellyroll structure 102, and there are some flattened copper tabs 208 on the bottom side of the jellyroll structure 102.

As shown in FIG. 5, the method 500 for forming cylindrical battery cell includes:
502, welding an aluminum current collector for the jellyroll structure.

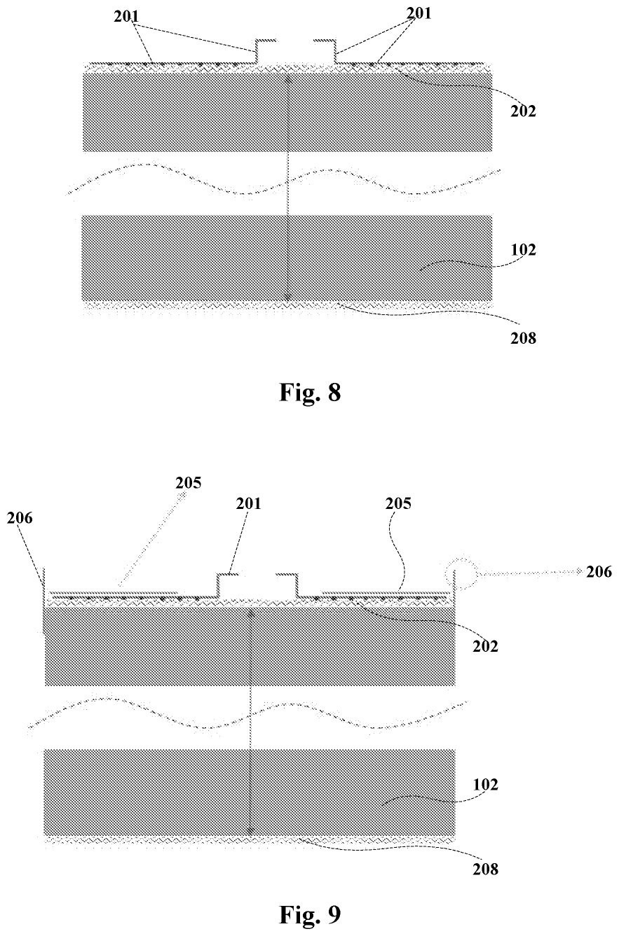

FIG. 8 is a diagram which shows the jellyroll structure in accordance with an embodiment of the present disclosure. As shown in FIG. 8, an aluminum current collector 201 and the flattened aluminum tabs 202 are pre-welded on the upper side of the jellyroll structure 102.

As shown in FIG. 5, the method 500 for forming cylindrical battery cell includes:
503, configuring an isolation foil and/or an isolation tape.

FIG. 9 is a diagram which shows the jellyroll structure in accordance with an embodiment of the present disclosure. As shown in FIG. 9, an isolation foil 205 is configured on the aluminum current collector 201 and an isolation tape 206 is wound around the jellyroll structure 102.

As shown in FIG. 5, the method 500 for forming cylindrical battery cell includes:
504, configuring a copper component on the lateral surface of the jellyroll structure.

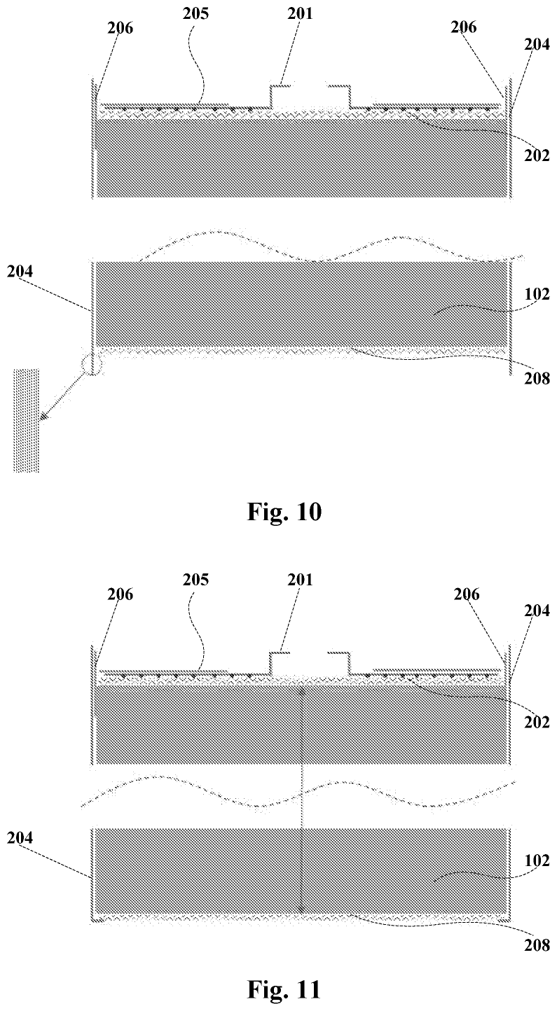

FIG. 10 is a diagram which shows the jellyroll structure in accordance with an embodiment of the present disclosure. As shown in FIG. 10, a copper component 204 is configured around the jellyroll structure 102.

For example, the copper component 204 is a copper foil which includes one or more layers. For another example, the copper component 204 is configured on the lateral surface of the jellyroll structure by winding one or more copper coils.

FIG. 11 is a diagram which shows the jellyroll structure in accordance with an embodiment of the present disclosure. As shown in FIG. 11, after a flattening process, the copper component 204 is flattened on the bottom side of the jellyroll structure 102.

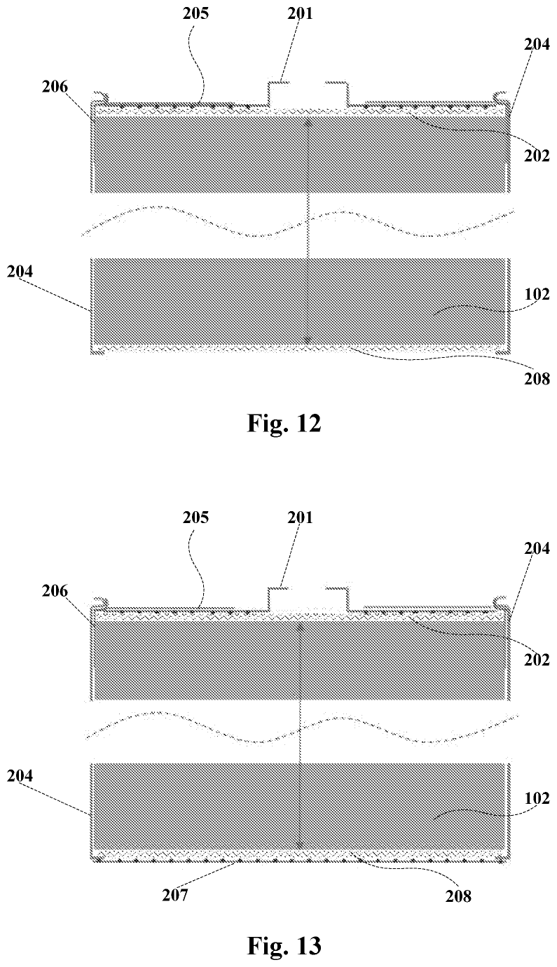

FIG. 12 is a diagram which shows the jellyroll structure in accordance with an embodiment of the present disclosure. As shown in FIG. 12, after a necking process, the isolation tape 206 and the copper component 204 are formed a necking shape on the upper side of the jellyroll structure 102.

As shown in FIG. 5, the method 500 for forming cylindrical battery cell includes:
505, welding one or more flattened tabs of the jellyroll structure with a copper current collector on a bottom side of the jellyroll structure, and
506, welding the copper component with the copper current collector.

FIG. 13 is a diagram which shows the jellyroll structure in accordance with an embodiment of the present disclosure. As shown in FIG. 13, a copper current collector 207 and the flattened copper tabs 208 are pre-welded on the bottom side of the jellyroll structure 102. Furthermore, as shown in FIG. 13, the copper component 204 is welded with the copper current collector 207.

As shown in FIG. 5, the method 500 for forming cylindrical battery cell includes:
507, inserting the jellyroll structure into the cell housing.

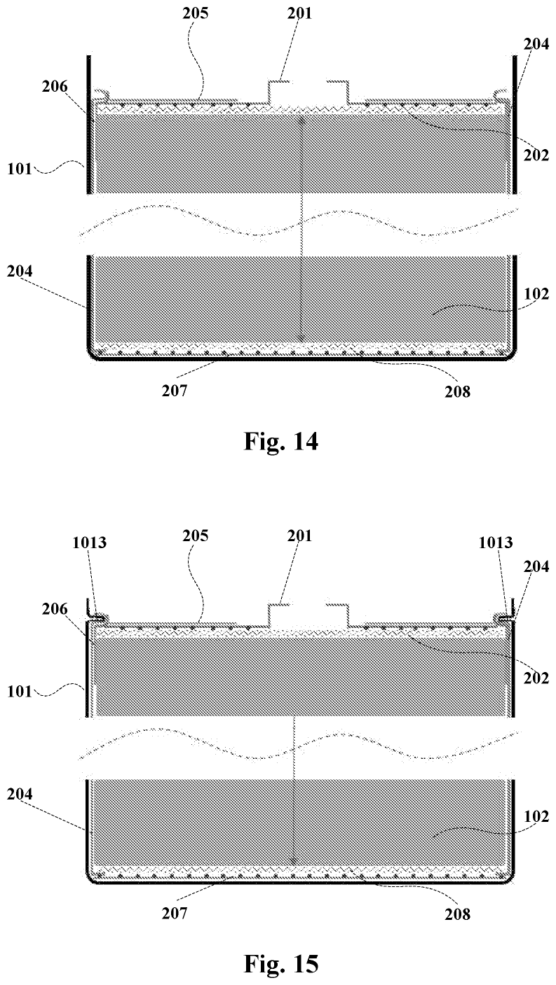

FIG. 14 is a diagram which shows a cell housing and the jellyroll structure in accordance with an embodiment of the present disclosure. As shown in FIG. 14, the jellyroll structure 102 is inserted into the cell housing 101.

As shown in FIG. 5, the method 500 for forming cylindrical battery cell includes:
508, crimping the upper side of the cell housing to form a crimped neck.

FIG. 15 is a diagram which shows the cell housing and the jellyroll structure in accordance with an embodiment of the present disclosure. As shown in FIG. 15, a crimped neck 1013 is formed by crimping the upper side of the cell housing 101. Furthermore, a part of the copper component 204 is arranged on the crimped neck 1013.

As shown in FIG. 5, the method 500 for forming cylindrical battery cell includes:
509, arranging the cap component 103 on the upper side of the cell housing, wherein the cap plate 1032 is supported by the crimped neck 1013 of the cell housing 101.

As shown in FIG. 5, a part of the copper component 204 is connected to the cap plate 1032 on the crimped neck 1013.

As shown in FIG. 5, the method 500 for forming cylindrical battery cell includes:
510, welding the aluminum terminal with the aluminum current collector by using a laser, after the jellyroll structure is inserted into the cell housing.

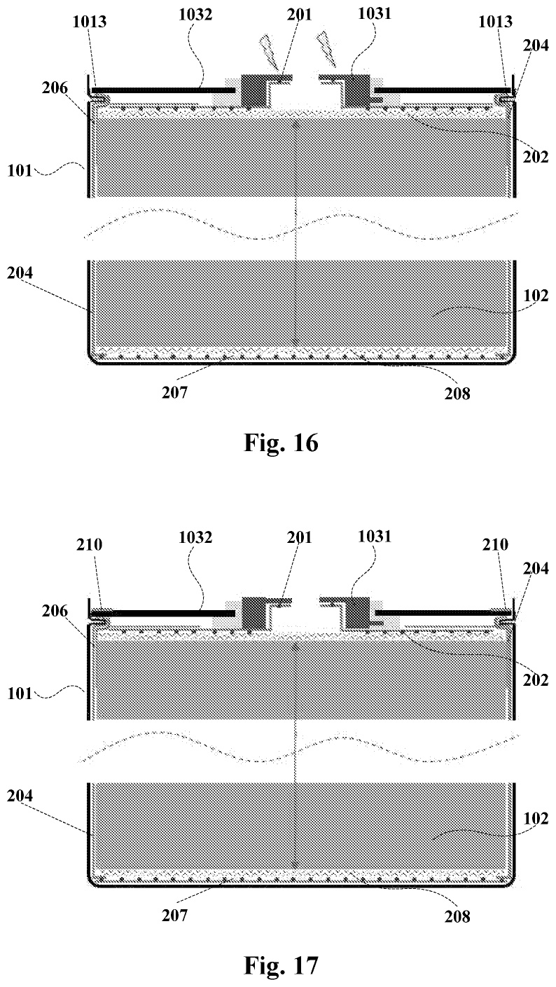

FIG. 16 is a diagram which shows the cell housing and the jellyroll structure in accordance with an embodiment of the present disclosure. As shown in FIG. 16, the cap component 103 is arranged on the upper side of the cell housing 101. The aluminum current collector 201 is weld with the aluminum terminal 1031 by using a laser from outside of the cell housing 101.

As shown in FIG. 5, the method 500 for forming cylindrical battery cell includes:
511, inserting a sealing ring on the cap plate to seal the cell housing.

FIG. 17 is a diagram which shows the cell housing and the jellyroll structure in accordance with an embodiment of the present disclosure. As shown in FIG. 17, a sealing ring (such as O-ring) 210 is inserted on the cap plate 1032.

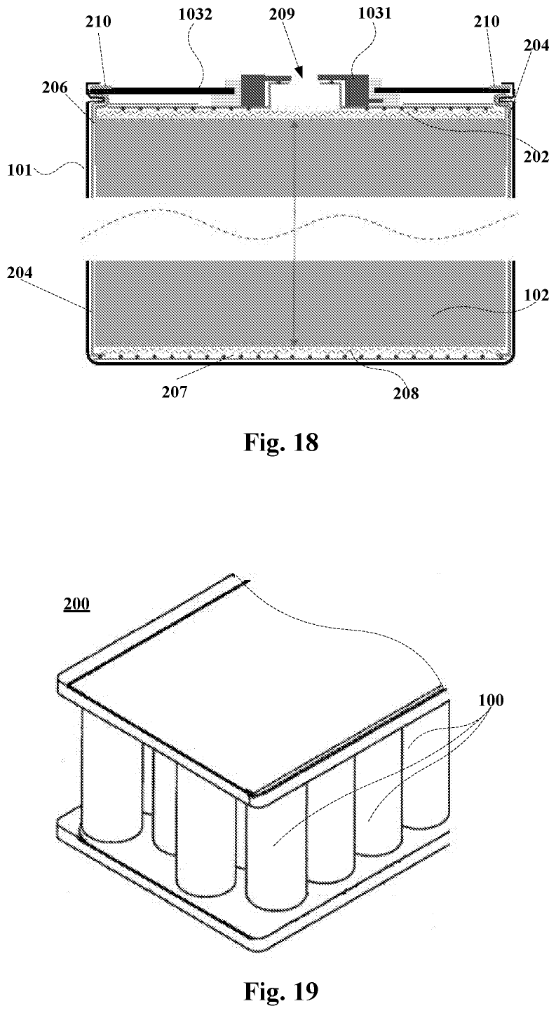

FIG. 18 is a diagram which shows the cell housing and the jellyroll structure in accordance with an embodiment of the present disclosure. As shown in FIG. 18, the upper side of the cell housing 101 is bended (crimped or closed). Afterwards, for example, as shown in FIG. 2, a sealing pin 203 is used to seal (for example by welding) the injection hole 209.

It should be appreciated that FIG. 5 is only an example of the disclosure, but it is not limited thereto. For example, the order of operations at blocks or steps may be adjusted, and/or, some blocks or steps may be omitted. Moreover, some blocks or steps not shown in FIG. 5 may be added.

Furthermore, some components or elements are illustrated only as examples in FIG. 7 to FIG. 18. However, it is not limited thereto, for example, connections or positions of the components or elements may be adjusted, and/or, some components or elements may be omitted.

It can be seen from the above embodiments, an aluminum terminal of a cap component is welded with an aluminum current collector, a cap plate of the cap component is connected to a copper component; the copper component is at least partly configured on a lateral surface of the jellyroll structure and is isolated from the aluminum current collector. Therefore, the thickness of the cell housing is decreased and an energy gravimetric and volumetric density of the cell is increased. Furthermore, the manufacturing process is simplified and costs consequently is reduced.

### A Third Aspect of Embodiments

A battery is provided in the embodiments. The corresponding devices and the method are illustrated in the first and second aspects of embodiments, and the same contents as those in the first and second aspects of embodiments are omitted.

In some embodiments, the battery includes a plurality of the cylindrical battery cell. The cylindrical battery cell is illustrated according to the first aspects of embodiments.

FIG. 19 is a diagram which shows a battery 200 in accordance with an embodiment of the present disclosure. As shown in FIG. 19, the battery 200 may include a plurality of the cylindrical battery cell 100.

It should be appreciated that FIG. 19 is only an example of the disclosure, but it is not limited thereto. For example, some components or elements are illustrated only as examples in FIG. 19. However, it is not limited thereto, for example, connections or positions of the components or elements may be adjusted, and/or, some components or elements may be omitted.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A cylindrical battery cell, at least comprising:
a cell housing having a cylindrical lateral portion and a bottom portion;
a jellyroll structure which is arranged inside the cell housing; and
a cap component which is configured on the jellyroll structure and is connected to the cylindrical lateral portion on an upper side of the cell housing;
wherein the cap component at least comprises an aluminum terminal and a cap plate, the aluminum terminal of the cap component being welded with an aluminum current collector which is welded with one or more flattened aluminum tabs of the jellyroll structure on an upper side of the jellyroll structure, the cap plate of the cap component being connected to a copper component; wherein the copper component is at least partly configured on a lateral surface of the jellyroll structure, and is isolated from the aluminum current collector.

2. The cylindrical battery cell according to claim 1, wherein the cap component further comprises an insulation element, the insulation element being configured between the cap plate and the aluminum terminal.

3. The cylindrical battery cell according to claim 2, wherein the cap plate is supported by a crimped neck of the cell housing, the cap plate having a hole in which the aluminum terminal is arranged.

4. The cylindrical battery cell according to claim 1, wherein
the copper component is a copper foil which comprises one or more layers, or, the copper component is configured on the lateral surface of the jellyroll structure by winding one or more copper coils.

5. (canceled)

6. The cylindrical battery cell according to claim 1, wherein an isolation foil and/or an isolation tape are/is configured between the copper component and the aluminum current collector, to electrically isolate the copper component from the aluminum current collector.

7. The cylindrical battery cell according to claim 1, wherein one or more flattened tabs of the jellyroll structure are welded with a copper current collector on a bottom side of the jellyroll structure, the copper component being welded with the copper current collector.

8. The cylindrical battery cell according to claim 1, wherein the aluminum terminal is welded with the aluminum current collector by using a laser, after the jellyroll structure is inserted into the cell housing.

9. The cylindrical battery cell according to claim 1, wherein the aluminum current collector is pre-shaped and an injection hole is created on the aluminum current collector, the injection hole being through the aluminum current collector and the aluminum terminal after the aluminum terminal is welded with the aluminum current collector.

10. The cylindrical battery cell according to claim 9, wherein the cylindrical battery cell further comprises:
a sealing pin which is used to seal the injection hole.

11. The cylindrical battery cell according to claim 1, wherein the cylindrical battery cell further comprises:
a sealing ring which is arranged on the cap plate.

12. A method for forming cylindrical battery cell, comprising:
forming a jellyroll structure and a cap component;
forming a cell housing having a cylindrical lateral portion and a bottom portion;
inserting the jellyroll structure into the cell housing; and
configuring the cap component on the jellyroll structure; the cap component being connected to the cylindrical lateral portion on an upper side of the cell housing;
wherein the cap component at least comprises an aluminum terminal and a cap plate, the aluminum terminal of the cap component being welded with an aluminum current collector which is welded with one or more flattened aluminum tabs of the jellyroll structure on an upper side of the jellyroll structure, the cap plate of the cap component being connected to a copper component; wherein the copper component is at least partly configured on a lateral surface of the jellyroll structure, and is isolated from the aluminum current collector.

13. The method according to claim 12, wherein the method further comprises:
configuring the copper component on the lateral surface of the jellyroll structure, or,
the method further comprises:
configuring an isolation foil and/or an isolation tape between the copper component and the aluminum current collector, to electrically isolate the copper component from the aluminum current collector.

14. (canceled)

15. The method according to claim 12, wherein the method further comprises:
welding one or more flattened aluminum tabs of the jellyroll structure with a copper current collector on a bottom side of the jellyroll structure, and
welding the copper component with the copper current collector.

16. The method according to claim 12, wherein the method further comprises:
welding the aluminum terminal with the aluminum current collector by using a laser, after the jellyroll structure is inserted into the cell housing.

17. A battery, comprising a plurality of cylindrical battery cells according to claim 1.

18. The battery according to claim 17, wherein the cap component further comprises an insulation element, the insulation element being configured between the cap plate and the aluminum terminal.

19. The battery according to claim 17, wherein the copper component is a copper foil which comprises one or more layers, or,
the copper component is configured on the lateral surface of the jellyroll structure by winding one or more copper coils.

20. The battery according to claim 17, wherein an isolation foil and/or an isolation tape are/is configured between the copper component and the aluminum current collector, to electrically isolate the copper component from the aluminum current collector.

21. The battery according to claim 17, wherein one or more flattened tabs of the jellyroll structure are welded with a copper current collector on a bottom side of the jellyroll structure, the copper component being welded with the copper current collector.

22. The battery according to claim 17, wherein the aluminum current collector is pre-shaped and an injection hole is created on the aluminum current collector, the injection hole being through the aluminum current collector and the aluminum terminal after the aluminum terminal is welded with the aluminum current collector.
